(19) United States
(12) Patent Application Publication
(10) Pub. No.: US 2008/0248311 A1
(43) Pub. Date: Oct. 9, 2008

(54) Antistatic Polymer Films with Improved Antistatic Properties

(76) Inventors: Kwang Suck Suh, Seongnam-Si (KR); Jong Eun Kim, Seoul (KR)

Correspondence Address: PARK LAW FIRM, 3255 WILSHIRE BLVD, SUITE 1110, LOS ANGELES, CA, 90010, US

(21) Appl. No.: 12/088,375

(22) PCT Filed: Oct. 4, 2006
(86) PCT No.: PCT/KR2006/004012

§ 371 Date: Mar. 27, 2008

(30) Foreign Application Priority Data
Oct. 4, 2005 (KR) 10-2005-0093182

(51) Int. Cl. B32B 9/04; B32B 9/00

(52) U.S. Cl. 428/408; 428/704

(57) ABSTRACT

Disclosed herein is a technology for preparing a novel conductive polymer film or sheet, which is used for antistatic purposes. Specifically, the antistatic polymer film comprises antistatic layers formed on a monolayer or multilayer polymer film using a conductive polymer as an active ingredient, and has a surface resistivity of 10-10 Ω/square, a decay time of less than 3 seconds, a tribo-voltage below 50 volts, and a charging voltage lower than applied voltage. Also, disclosed is an antistatic product made from such a conductive polymer film.

### TECHNICAL FIELD

The present invention relates to an antistatic polymer film or sheet (hereinafter, referred to as a “film”) having improved antistatic properties, and more particularly to a novel antistatic polymer film, in which antistatic layers containing a conductive polymer as an active ingredient are formed on the surfaces of a monolayer or multilayer polymer film having volume resistivity, so that the antistatic polymer film has a surface resistivity of 10³-10⁹ Ω/square, a decay time of less than 3 seconds, a tribo-voltage below 50 volts, and a charging voltage lower than applied voltage.

### BACKGROUND ART

Precise electronic parts, such as semiconductor integrated circuit chips or various modules, must be transported in antistatic treated containers in order to be able to prevent them from being damaged by static electricity occurring during the transport thereof. For example, a tray, which is a container for transporting electronic parts, will have charges accumulated on the tray surface due to friction with electronic parts or contact with parts of the human body during the transport or handling thereof. Such surface charges cause so-called static electricity, and must be suitably discharged in order to protect electronic parts.

Recently, the integration density and precision of semiconductors and applied semi-conductor products have increased, and the antistatic properties of containers for the transport of these electronic parts have thus been enhanced. For example, trays, which were sufficient to perform the intended use thereof with a surface resistivity of only about 10¹⁰ Ω/square, have recently required antistatic properties including a surface resistivity of 10³-10⁹ Ω/square, a decay time of less than 3 seconds, and a tribo-voltage below 50 volts. Such enhanced antistatic properties strictly apply particularly to trays for the transport of precise electronic parts, such as heads for computer hard disks.

Techniques capable of suppressing the generation of impurities while satisfying these antistatic properties broadly include either a method that uses a conductive polymer, or a method that comprises adding an organic material having a specific degree of conductivity, i.e., an inherently dissipative polymer (IDP).

Trays for the transport of computer heads, which have been used in the past, employ a film prepared by mixing a polymer having a resistivity of about 10⁹-10¹⁰ Ω/square, i.e., an antistatic material, called IDP (inherently dissipative polymer), with a polymer material, to provide a film with a surface resistivity and volume resistivity of about 10⁹-10¹⁰ Ω/square or 10⁹ Ω.cm. This material is currently widely used as an antistatic material for the preparation of almost all containers for parts for computer heads.

This material is a good material provided with both surface conductivity and volume conductivity, because it consists of a mixture of a polymer material with the material called IDP. However, it has problems in that limitations arise in increasing the surface conductivity thereof (upper limit of surface resistance: 10⁸ Ω/square), and in some cases, the tribo-voltage thereof exceeds 50 volts, because the surface resistance of a portion that is stretched in a thermoforming process is likely to increase. Such problems can become severe with an increase in integration density. Particularly, if applied voltage is applied to this material, the material will show a characteristic of being able to be charged with a voltage above the applied voltage, which has been pointed out as the greatest shortcoming of this material.

Accordingly, in the art to which the present invention pertains, there is a need to invent a novel antistatic material, which satisfies the above-described requirements, including a surface resistivity of about 10³-10⁹ Ω/square, a decay time of less than 3 seconds and a tribo-voltage below 50 volts, and at the same time, is charged with a voltage below applied voltage.

### DISCLOSURE OF INVENTION

### Technical Problem

It is an object of the present invention to invent a novel antistatic polymer film, which has a surface resistivity adjustable in the range of 10³-10⁹ Ω/square, a decay time of less than 3 seconds, a tribo-voltage below 50 volts, and a charging voltage much lower than applied voltage, as well as an antistatic product made therefrom.

### Technical Solution

To achieve the above object, the present invention provides an antistatic polymer film having volume resistivity and surface resistivity, which comprises: an antistatic base polymer film having a monolayer or multilayer structure, the base polymer film containing an antistatic agent and thus having antistatic performance; and antistatic layers formed on the surfaces of the base polymer film using a conductive polymer as an active ingredient, said antistatic polymer film having excellent antistatic properties, including a surface resistivity adjustable in the range of 10³-10⁹ Ω/square, a decay time of less than 3 seconds, a tribo-voltage below 50 volts, and a charging voltage lower than actually applied voltage.

Also, the present invention employs either a method of imparting antistatic properties through both the surface and volume of the polymer film having volume conductivity by coating both surfaces of the film with a conductive polymer coating solution containing a conductive polymer and a binder as active ingredients, or a technique comprising forming a base polymer into a structure consisting of one or more layers, adding an antistatic agent to both surface layers of the base polymer structure, adjusting the thickness of the surface layers to 5-50% relative to the total thickness of the base polymer structure, and then forming on the outermost portion of the structure an antistatic layer containing a conductive polymer as an active ingredient. When the base polymer is formed into the multilayer structure, it is preferable to make the base polymer into a three-layer structure, containing an antistatic agent in both surfaces thereof, and having a middle layer made of an insulating material.

### Advantageous Effects

The use of the inventive technology can prepare a polymer film or sheet, which has a surface resistivity adjustable in the range of 10³-10⁹ Ω/square, a decay time of less than 3 seconds, a tribo-voltage below 50 volts, and a charging voltage much lower than the voltage actually applied to the surface thereof, and thus possesses a very good antistatic property. The prepared film can be used to prepare trays for the transport of precise electronic parts, and other products.

### BRIEF DESCRIPTION OF THE DRAWINGS

FIG. 1 is a cross-sectional view of an antistatic polymer film having improved antistatic performance, according to one embodiment of the present invention.

FIG. 2 is a cross-sectional view of an antistatic polymer film having improved antistatic performance, according to another embodiment of the present invention.

### MODE FOR THE INVENTION

Previously developed methods may be used to form on the surface of a base polymer material an antistatic layer containing a conductive polymer and a binder component as active ingredients. As the previously developed methods, Korean Patent Application Nos. 10-1999-10982 and 10-2001-20546 disclose techniques capable of preparing a transparent polymer film and sheet having excellent antistatic ability by mixing a conductive polymer such as polyaniline, polypyrrole or polythiophene, or a modified conductive polymer such as poly(3,4-ethylenedioxythiophene), with at least one binder selected from among binders containing at least one functional group selected from among acryl, urethane, epoxy, amide, imide, ester, carboxy, hydroxy, silane, titanate and silicate, to make a conductive coating solution, applying the coating solution on the surface of a polymer material, and then drying the coated solution, to form a conductive layer on the polymer material surface.

The invention disclosed in said patent applications relates to a so-called solution coating method of forming the surface conductive layer using the coating solution prepared by dissolving the conductive polymer in a binder and solvent, but the same effects as those of said patent applications can also be obtained using a so-called interfacial polymerization or vapor phase polymerization process, in which a monomer for producing a conductive polymer is brought into direct contact with a polymer surface to synthesize the conductive polymer directly on the polymer surface (e.g., Japanese Patent Laid-Open Publication No. Hei 5-320388).

Also, the invention disclosed in said patent applications relates to the method of imparting surface conductivity by forming on the film surface an antistatic layer h aving a small thickness of less than a few microns, and can show excellent antistatic performance on the film surface. However, because the middle layer, which forms a large part of the film material, is made of a substrate consisting of an insulating material, the middle substrate itself, rather than the coating surface, has insulation value, and thus shows a volume resistivity higher than 10¹² Ω.cm and a decay time of more than a few tens of seconds, resulting in a reduction of antistatic properties.

To solve this shortcoming, the present invention uses a method of increasing the thickness of the surface layer to improve antistatic performance in the case where the base polymer layer is provided with volume resistivity or where the base polymer has a three-layer structure. Various methods can be used to provide the base polymer with volume resistivity, in which particulate fillers such as carbon black, carbon fiber, doped metal oxide or metal particles may be used, and an organic compound, so-called IDP (inherently dissipative polymer) having antistatic properties, or organic substances such as various surfactants, can also be mixed with the base polymer. Among these substances, the most preferred is the inherently dissipative polymer (IDP), which has no particulate impurity and does not greatly deteriorate the physical properties of the base polymer, and the surfactants have a high surface resistivity of 10¹⁰ Ω/square and have a characteristic such that they migrate onto the surface of the polymer with the passage of time, or the performance thereof disappears with the passage of time; however, the conductive polymer layer formed on the polymer surface can be effectively used to prevent this phenomenon from occurring on the polymer surface. Also, when carbon black and metal oxide are used to impart antistatic properties to the base polymer, low surface resistivity and volume resistivity can be observed, but the conductive polymer film coated on the base polymer layer can show an advantageous effect of preventing foreign materials such as carbon black or metal oxide from becoming detached.

In the present invention, the conductive polymer synthesized in forming the antistatic layer on the surface of the base polymer film is preferably used in a mixture with a polymer binder, and it is more preferable to form the antistatic layer using other additional components, if necessary. For formation of the antistatic layers on the base polymer as described above, reference can be made to existing patents. As the conductive polymer, it is preferable to use a conductive polymer such as polythiophene, polyaniline or polypyrrole, or a modified conductive polymer such as poly(3,4-ethylenedioxythiophene). Also, the monomer which is used to synthesize the conductive polymer can preferably be a modified monomer such as thiophene, aniline, pyrrole or 3,4-ethylenedioxythiophene.

The base polymer, as the polymer material of the above-described film or sheet having volume resistivity, consists of polyester polymer, styrenic polymer, olefinic polymer, carbonate polymer or a copolymer containing at least one of said polymers, and a commercially available antistatic sheet (e.g., M690, Noveon, USA) can be used without any further treatment.

As used herein, the term “antistatic” means a phenomenon occurring mainly on surfaces, in which charges formed on the surface of a polymer material in contact therewith or in the atmosphere are attenuated through a suitable pathway. Thus, antistatic performance must be exhibited mainly on surfaces, and it is most effective to cause the remaining charges penetrating into the film to disappear through a suitable pathway. Accordingly, it is most effective for imparting antistatic properties to prepare a material such that it maintains a volume resistivity of about 10⁹-10¹⁰ Ω/square while maintaining a surface resistivity of about 10⁶-10⁹ Ω/square.

As described above, the surfactant and inherently dissipative polymer (IDP) among said antistatic agents are most advantageous for imparting antistatic properties to the base polymer. Examples of surfactants, which can be used in the present invention, include salts such as ammonium sulfate and phosphate, and preferred examples of IDP, which can be used in the present invention, include all kinds of IDPs, such as polyetheramides, polyesteramides, polyetheresteramides, and polyurethanes. About 1-50 parts by weight of these antistatic components can be mixed with polymer pellets to be used as a base polymer, and can then be extruded to prepare a film or sheet. Alternatively, a final product can also be directly prepared by injection molding.

Hereinafter, the antistatic film according to the present invention will be described in detail with reference to the accompanying drawings.

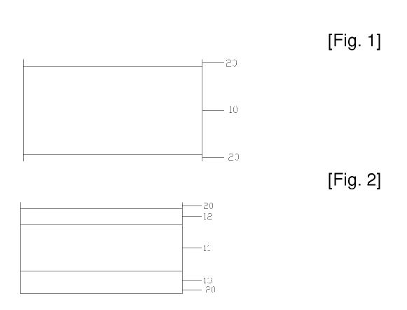

FIG. 1 is a cross-sectional view of a film prepared using a method in which a conductive polymer 20 containing a conductive polymer as a main component is coated on both surfaces of a base polymer 10 having antistatic properties to impart resistivity and volume resistivity to both surfaces of the base polymer 10. The film according to FIG. 1 is the simplest structure according to the present invention. Thus, the film according to FIG. 1 is the preferable structure in terms of mass production and reduction in production cost, which result from a simple production process thereof, and it has both surface resistivity and volume resistivity.

FIG. 2 is a cross-sectional view of a film prepared using a method in which a conductive layer coating containing a conductive polymer as a main component is formed on the surface of a base polymer film having a three-layer structure, which is a typical layer structure among base polymer films having a multilayer structure. In this case, an antistatic agent can be added to a middle layer 11 and surface layers 12 and 13 of a base polymer to impart volume conductivity thereto. Also, the same effect can be obtained even if the antistatic agent is added only to the surface layers 12 and 13 while maintaining the insulating property of the middle layer 11.

Specifically, methods of making a multilayer structure can be used in the pre paration of the base polymer having volume conductivity, and can be further classified into two methods. The first method is a method in which the above-described antistatic agent is added to each of the layers of the base structure having the three-layer structure as shown in FIG. 2 so as to impart volume conductivity to each layer. The second method is a technique in which the antistatic agent is added only to the surface layers of the base polymer while imparting the middle layer with insulation value, and then the antistatic layer containing a conductive polymer as an active ingredient as described above is formed on the uppermost layer of the base film. The two methods can both satisfy antistatic property requirements, including a surface resistivity of 10³-10⁹ Ω/square, a decay time of less than 3 seconds, a tribo-voltage below 50 volts, and a charging voltage lower than applied voltage.

To impart volume conductivity to the base polymer, one or a mixture of two or more selected from among the above-described antistatic agents can also be added to the base polymer. Depending on the intended use of the base polymer, a colored an tistatic agent, such as carbon black, can be used in the case where it is preferable that the antistatic polymer film be opaque and have a color, because the antistatic layer containing a conductive polymer as an active ingredient is formed thin. Also, carbon black can be used in a mixture with other metal oxides or IDP so as to conform to the characteristics of the base polymer and the intended use of the antistatic polymer film according to the present invention. Moreover, when the base polymer has a multilayer structure, different antistatic agents can be added to each layer of the multilayer structure, and in the case of both surface layers of a three-layer structure, for example, carbon black can be used in one surface layer of the structure, and IDP can be used in the other surface layer. Specifically, the antistatic agent can be designed and prepared to be appropriate to the characteristics of the base polymer and the intended use of the antistatic polymer film according to the present invention.

The technology of the present invention can be applied to most polymers, including ester polymer, styrenic polymer, olefinic polymer, carbonate polymer, mixtures thereof, or copolymers containing at least one selected from these polymers.

Hereinafter, the present invention will be described in detail with reference to examples. It is to be understood, however, that the scope of the present invention is not limited to these examples.

### COMPARATIVE EXAMPLE 1

10 g of a poly(3,4-ethylenedioxythiophene) dispersion (Baytron PH, H. C. Starck, Germany) as a conductive polymer, 20 g of a urethane binder (U710, ALBERDINGK, Germany), 1 g of ethylene glycol, 1 g of N-methyl-2-pyrrolidone, and 0.01 g of a fluorine-based lubricant were mixed with each other in 67.99 g of a mixed solvent of water and isopropyl alcohol (15:85) to prepare an antistatic coating solution. The coating solution was applied to the surface of an amorphous polyester sheet to prepare an antistatic amorphous polyester sheet.

The amorphous polyester sheet thus prepared had a surface resistivity of 10⁶ Ω/square, a tribo-voltage below 20 volts, and a low charging voltage of about 400 volts, as measured upon the application of 1,000 volts, suggesting that the surface antistatic properties of the film were excellent. On the other hand, it had a volume resistivity above 10¹² Ω.cm and a decay time of more than 10 seconds.

### COMPARATIVE EXAMPLE 2

3 parts by weight of quaternary ammonium sulfate as a surfactant was kneaded with high-impact polystyrene resin using a melt kneader at a temperature of 130° C. for 10 minutes to prepare an antistatic polystyrene, which was then prepared into a 1-mm thick sheet using a compression molding machine.

The antistatic polystyrene sheet thus prepared had a volume resistivity of 10¹⁰ Ω.cm and a decay time of about 3 seconds, which were good. However, it had a surface resistivity of 10¹¹ Ω/square, a tribo-voltage of 750 volts and a charging voltage of 1,500 volts upon the application of 1,000 volts, which were very high.

### COMPARATIVE EXAMPLE 3

Comparative Example 3 was carried out in the same manner as in Comparative Example 2, except that amorphous polyester was used as the polymer material, and the surfactant was mixed at a temperature of 300° C.

The antistatic amorphous polyester sheet thus prepared had a volume resistivity of 10¹⁰ Ω.cm and a decay time of about 3 seconds, which were good. However, it had a surface resistivity of 10¹¹ Ω/square, a tribo-voltage of 350 volts, and a charging voltage of 1,400 volts upon the application of 1,000 volts, which were very high.

### EXAMPLE 1

In Example 1, the conductive coating solution prepared according to the method of Comparative Example 1 was applied to the surface of the antistatic polystyrene sheet prepared in Comparative Example 2, and was then dried, to form a conductive layer on the surface of the sheet.

The antistatic polystyrene sheet thus prepared had a surface resistivity of 10⁶ Ω/square, a tribo-voltage of 25 volts, a volume resistivity of 10¹⁰ Ω.cm, a decay time of less than 0.5 seconds, and a particularly low charging voltage of about 400 volts upon the application of 1,000 volts.

### EXAMPLE 2

In Example 2, the conductive coating solution prepared according to the method of Comparative Example 1 was applied to the surface of the antistatic amorphous polyester sheet prepared in Comparative Example 3, and was then dried, to form a conductive layer on the surface of the sheet.

The antistatic amorphous polyester sheet thus prepared had a surface resistivity of 10⁶ Ω/square, a tribo-voltage of 20 volts, a volume resistivity of 10¹⁰ Ω.cm, a decay time of less than 0.1 seconds, and a charging voltage of 400 volts upon the application of 1,000 volts.

### EXAMPLE 3

In Example 3, the conductive coating solution prepared according to the method of Comparative Example 1 was applied to the sheet of a commercially available amorphous polyester sheet, followed by drying, to form a conductive layer on the surface of the sheet.

The amorphous polyester sheet thus prepared had a surface resistivity of 10⁶ Ω/square, a tribo-voltage of 20 volts, a volume resistivity of 10¹⁰ Ω.cm, a decay time of less than 0.1 seconds, and a low charging voltage of about 400 volts upon the application of 1,000 volts.

### EXAMPLE 4

In Example 4, a three-layer co-extruder was used to a base polymer having a three-layer structure consisting of a middle layer made of an insulating high-impact polystyrene and surface layers made of the antistatic agent/polystyrene mixture prepared using the technique of Comparative Example 2, the three-layer structure having a thickness ratio of 20 (surface layer): 60 (middle layer): 20 (surface layer). Then, the coating solution prepared using the method of Comparative Example 1 was applied to the outermost surfaces of the resulting structure, followed by drying, thus forming conductive layers on the surfaces of the structure.

The antistatic amorphous polyester sheet thus prepared had a surface resistivity of 10⁶ Ω/square, a tribo-voltage of 20 volts, a volume resistivity of 10¹⁰ Ω.cm, a decay time of less than 0.1 seconds, and a low charging voltage of about 400 volts upon the application of 1,000 volts.

From the comparison between the results of Comparative Examples and Examples, the polymer sheets prepared using the techniques of Comparative Examples 1-3 resulted in good surface conductivity but poor volume conductivity, or good volume conductivity but poor surface conductivity. However, the polymer sheets prepared using the techniques disclosed in Examples 1-4 could satisfy the requirements of trays for the transport of precise electronic components, which must have a surface resistivity of about 10⁶ Ω/square, a tribo-voltage below 20 volts, a decay time of less than 3 seconds, and low charging voltage.

### INDUSTRIAL APPLICABILITY

As described above, the antistatic polymer film according to the present invention can be used to manufacture containers such as trays, which can safely store and manage parts or products, such as semiconductor chips, which are sensitive to static electricity.

1. An antistatic polymer film having volume resistivity and surface resistivity, which comprises:
an antistatic base polymer film having a monolayer or multilayer structure, the base polymer film containing an antistatic agent and thus possessing antistatic performance; and
antistatic layers formed on the surfaces of the base polymer film using a conductive polymer as an active ingredient,
said antistatic polymer film having excellent antistatic properties, including a surface resistivity adjustable in the range of 10³-10⁹ Ω/square, a decay time of less than 3 seconds, a tribo-voltage below 50 volts, and a charging voltage lower than actually applied voltage.

2. The antistatic polymer film of claim 1, wherein the antistatic agent is at least one selected from among surfactants, inherently dissipative polymers (IDP), metal oxides, and carbon black.

3. The antistatic polymer film of claim 1, wherein the conductive polymer synthesized during formation of the antistatic layer on the surface of the base film is used in a mixture with a polymer binder.

4. The antistatic polymer film of claim 3,
wherein the conductive polymer is selected from among conductive polymers, including polythiophene, polyaniline and polypyrrole, and modified conductive polymers, including poly(3,4-ethylenedioxythiophene).

5. The antistatic polymer film of claim 1,
wherein the antistatic layer is formed through a vapor phase polymerization or direct polymerization process using the conductive polymer as an active ingredient.

6. The antistatic polymer film of claim 5, wherein a monomer used for the synthesis of the conductive polymer is selected from among modified monomers, including thiophene, aniline, pyrrole and 3,4-ethylenedioxythiophene.

7. The antistatic polymer film of claim 1,
wherein the base polymer consists of ester polymer, styrenic polymer, olefinic polymer, carbonate polymer, or a copolymer containing at least one of these polymers.

8. The antistatic polymer film of claim 1,
wherein the base polymer film has a layer structure consisting of three layers or more, in which the antistatic agent is contained in layers formed on both surfaces of the layer structure.

9. The antistatic polymer film of claim 8, wherein the ratio of the thickness of both surface layers of the layer structure is 5-50% relative to the total thickness of the layer structure.

10. The antistatic polymer film of claim 2, wherein the conductive polymer synthesized during formation of the antistatic layer on the surface of the base film is used in a mixture with a polymer binder.

11. The antistatic polymer film of claim 10, wherein the conductive polymer is selected from among conductive polymers, including polythiophene, polyaniline and polypyrrole, and modified conductive polymers, including poly(3,4-ethylenedioxythiophene).

12. The antistatic polymer film of claim 2, wherein the antistatic layer is formed through a vapor phase polymerization or direct polymerization process using the conductive polymer as an active ingredient

13. The antistatic polymer film of claim 12, wherein a monomer used for the synthesis of the conductive polymer is selected from among modified monomers, including thiophene, aniline, pyrrole and 3,4-ethylenedioxythiophene.

14. The antistatic polymer film of claim 2, wherein the base polymer consists of ester polymer, styrenic polymer, olefinic polymer, carbonate polymer, or a copolymer containing at least one of these polymers.

15. The antistatic polymer film of claim 2, wherein the base polymer film has a layer structure consisting of three layers or more, in which the antistatic agent is contained in layers formed on both surfaces of the layer structure.

16. The antistatic polymer film of claim 17, wherein the ratio of the thickness of both surface layers of the layer structure is 5-50% relative to the total thickness of the layer structure.

17. The antistatic polymer film of claim 3, wherein the base polymer film has a layer structure consisting of three layers or more, in which the antistatic agent is contained in layers formed on both surfaces of the layer structure.

18. The antistatic polymer film of claim 17, wherein the ratio of the thickness of both surface layers of the layer structure is 5-50% relative to the total thickness of the layer structure.

19. The antistatic polymer film of claim 4, wherein the base polymer film has a layer structure consisting of three layers or more, in which the antistatic agent is contained in layers formed on both surfaces of the layer structure.

20. The antistatic polymer film of claim 19, wherein the ratio of the thickness of both surface layers of the layer structure is 5-50% relative to the total thickness of the layer structure.
